(19) United States
(12) Patent Application Publication
(10) Pub. No.: US 2006/0104263 A1
(43) Pub. Date: May 18, 2006

(54) Method of setting up connections for access by roaming user terminals to data networks

(75) Inventors: Madhu-Kumar Krishnan, (US); Olivier Martinot, Draveil (FR); Guy Mathieu, Orsay (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/270,481

(22) Filed: Nov. 10, 2005

(30) Foreign Application Priority Data
Nov. 17, 2004 (FR) 0452655

(51) Int. Cl. H04L 12/66

(52) U.S. Cl. 370/352

(57) ABSTRACT

A method is disclosed that is dedicated to setting up connections for access to data networks from communication terminals used by users having subscriptions corresponding to connection profiles with “main” service providers, via private networks of service providers and access networks of different types. The method consists in: i) assigning each of said users a general user identifier for each type of access network and storing each general user identifier in corresponding relationship to the connection profile in a “main” memory; ii) in the event of connection of a terminal to one of said access networks, associated with a host private network, by means of a general user identifier, determining in said main memory if it contains said general user identifier and, if so, copying at least a subset of the corresponding connection profile into an auxiliary memory of said host private network; iii) configuring said host private network and said access network to which said terminal is connected as a function of at least a part of said copied subset so as to set up a connection.

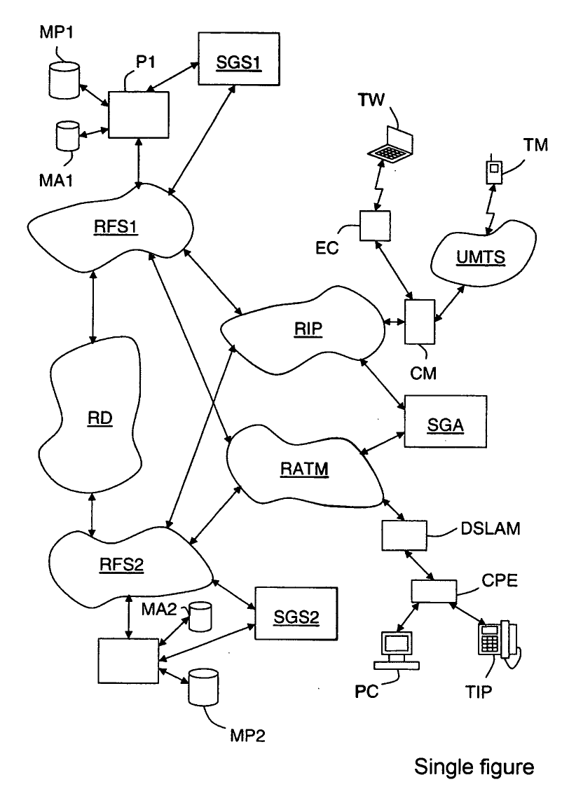

### CROSS-REFERENCE TO RELATED APPLICATIONS

This application is based on French Patent Application No. 0452655 filed 17/11/2004, the disclosure of which is hereby incorporated by reference thereto in its entirety, and the priority of which is hereby claimed under 35 U.S.C. §119.

### BACKGROUND OF THE INVENTION

1. Field of the invention

The invention concerns communication networks, and to be more precise setting up low bit rate or high bit rate connections to data networks from user terminals, where applicable roaming user terminals.

Here the term “connection” refers to any type of connection set up between a communication terminal and a data network, for example the Internet, via a physical access provider and a service provider (which may be one and the same). It may therefore be a question of a radio connection (for example a GPRS, UMTS, WiFi or WiMAX connection), an optical cable (optical fiber) connection, or an xDSL (x Digital Subscriber Line) connection over a balanced or unbalanced pair using otherwise unused frequencies of public switched telephone network (PSTN) lines, and in particular an ADSL (Asymmetric DSL), HDSL (High bit rate DSL), RDSL (Rate Adaptive DSL), VDSL (Very high bit rate DSL) or SDSL (Single line DSL) connection.

Here the expression “communication terminal” refers to any communication equipment that can be connected to an access network, such as a public switched telephone network (PSTN), for example, a mobile telephone network (or cellular radio network), or a WiFi radio network. It may therefore be a question of a fixed or mobile telephone, an Internet Protocol telephone, a fixed or portable computer, a personal digital assistant (PDA), a games console or a television terminal, provided that it has an internal or external high bit rate modem.

2. Description of the Prior Art

Some communication terminal users, in particular those referred to as “roaming” users, may frequently need to connect to a data network, possibly a high bit rate data network, from various locations and/or using different types of communication terminals. This could be the situation of a person with more than one home, for example, a person traveling for business and/or personal reasons, or a person who is in transit in a train station or airport.

A roaming user may be obliged to connect his computer at a first location to a physical access network of a first type, for example a PSTN/ADSL network when at his home or office, using a first access provider, and at a second location to a physical access network of the first type or a second type, using a second access provider.

In this situation, the user has a subscription to a connection, possibly a high bit rate connection, associated with the telephone number of a first telephone line situated in the first location and corresponding to a certain connection profile. For the second telephone line, which is situated in the second location and associated with a second telephone number, there are various possibilities:

the user or “proprietor” of the first line has taken out a second subscription for the second line with the same access and service providers as the first subscription associated with the first line; in this case, the user may connect his computer thereto but will obtain a connection whereof the bandwidth is limited by the connection profile corresponding to the second subscription rather than that corresponding to the subscription for the first line; on the other hand, he will have the same profile with the service provider (list of services, billing details);

the user or “proprietor” of the first line has taken out a second subscription for the second line with a different service provider than the first line and with a second connection profile different from the first profile; in this case, he can connect to the second line, which is possibly a high bit rate line, in accordance with the second connection profile; on the other hand, he will have two profiles with the service providers (two lists of services, two sets of billing details, etc.);

the second telephone line is not usable for high bit rate access (for example because there is no subscription therefor or because the proprietor does not allow use of his own high bit rate access); in this case, the user of the second line is obliged to use a low bit rate connection on the conventional PSTN second line, and may therefore be constrained to pay his service provider or the local access provider an additional sum depending on the duration of his connection on the second telephone line, for example.

For example, a user may also be obliged to connect his computer at a first location to an access network of the first type, for example a PSTN, belonging to a first access provider and to connect his mobile telephone (or his WiFi terminal) at a second location (that may be the same as the first location) to an access network of a second type, for example a UMTS network, belonging to a second access provider.

In the above situation, the user must have, firstly, with a first service provider, a first subscription for a high bit rate connection associated with the telephone number of the first telephone line at the first location and, secondly, with a second service provider (which may be the same as the first service provider) a second subscription for a high bit rate connection associated with the telephone number of his mobile telephone.

Solutions exist in third generation mobile networks, as described in the article “User Profile Identification in Future Mobile Telecommunications Systems” by G. P. Eleffheriadis and M. E. Theologou. However, that solution applies exclusively to roaming terminals (and more particularly to UMTS terminals) and takes no account of fixed terminals (for example ADSL terminals) and therefore of the constraints associated with fixed terminals.

One object of the invention is therefore to improve upon the above situation, and in particular to enable a roaming user to obtain a connection, where applicable a high bit rate connection, corresponding if possible to a selected connection profile, for any of his communication terminals and/or from any location authorizing such connection, as well as enabling centralized charging and/or billing and the definition of connection profiles as a function of local constraints, in particular local technical constraints.

### SUMMARY OF THE INVENTION

To this end the present invention proposes a method dedicated to setting up connections for access to at least one data network from communication terminals used by users having subscriptions corresponding to (optionally high bit rate) connection profiles with “main” service providers, via private networks of service providers and access networks of different types, interconnected by transport networks of different types.

The method consists in:
assigning each of said users a general user identifier for each type of access network and storing each general user identifier in corresponding relationship to the connection profile in a “main” memory;
in the event of connection of a terminal to one of said access networks, associated with a private network of a host service provider, by means of a general user identifier, determining in said main memory if it contains said general user identifier and, if so, copying at least a subset of the corresponding connection profile into an auxiliary memory of said host private network;
then configuring said host private network, said access network to which said terminal is connected and the transport network that connects them as a function of at least a part of said copied (and stored) subsets so as to set up a connection between said terminal and said host private network;
said host private network sending charging and/or billing data to said private network of said main service provider in order for it to manage the billing of each connection for its user clients and/or for it to bill the service rendered for each host connection.

The method of the invention may have other features, and in particular, separately or in combination:
there may be communicated to the private network of the host service provider, by means of the terminal connected to the associated access network, data representing the general user identifier and a user name and/or a password, so as to authenticate the user;
the user data is communicated by means of at least one secure message, for example;
on receiving the user data, the private network of the host service provider may determine the main service provider of the user in order to send its main private network the user data, and, on receiving the user data, the main private network verifies that it in fact corresponds to a client having a subscription for a high bit rate connection, and, if so, it determines in the main memory the subscription connection profile in order to send to the private network of the service provider a subset of the connection profile in order for it to be stored in the auxiliary memory;
the host service provider may perform an additional security check on a user requesting a connection in order to confirm access authorization and/or to complete a local connection profile (defining the bit rate and/or the quality of service (QoS));
the additional security check consists in setting up a telephone connection with the user in order to request from him a connection request confirmation and/or the communication of identification data;
the host private network may initiate the setting up of the connection with the terminal as a function of the subset of the connection profile stored in the auxiliary memory and local constraints;
there may be provided at least one access management system connected to the transport networks and to the access networks associated therewith so as to configure them selectively to set up the connections;
the access management system may further be connected to the private networks in order to configure them selectively for setting up the connections;
the services management systems may instead be connected to the respective private networks in order to configure them selectively for setting up the connections;
a main memory and an auxiliary memory may be provided in each of the private networks of the service providers.

The invention is particularly well suited, although not in any way that limits the scope of invention, to xDSL connections, radio connections (for example GPRS, UMTS, WiFi or WiMAX connections) and optical cable connections (optical fiber connections).

### BRIEF DESCRIPTION OF THE DRAWING

Other features and advantages of the invention will become apparent on reading the following detailed description and examining the appended drawing, the single figure whereof shows in highly diagrammatic form one example of combining communication networks enabling implementation of the method of the invention for setting up high bit rate connections. The appended drawing constitutes part of the description of the invention as well as contributing to the definition of the invention, if necessary.

### DETAILED DESCRIPTION OF THE PREFERRED EMBODIMENT

As indicated hereinabove, one object of the invention is to enable a user, possibly a roaming user, to obtain a connection, possibly a high bit rate connection, corresponding as much as possible to a selected connection profile, for any of his communication terminals and/or from any location authorizing such a connection, and to centralize the user connection profiles and the charging and/or billing of main connection services and host connection services.

The invention concerns any type of low bit rate connection or high bit rate connection and any type of communication terminal equipped with a modem, as defined in the introduction, and in particular xDSL connections of Internet Protocol (IP) telephones (TIP) or fixed or portable personal computers (PC) or personal digital assistants (PDA) or games consoles or television terminals to the telephone lines of a public switched telephone network (PSTN), radio connections (for example GPRS, UMTS, WiFi or WiMAX connections) of mobile telephones (TM) or portable computers (TW), or optical connections of fixed or portable computers or games consoles or television terminals to optical fiber cables.

As shown in the single figure, there is considered hereinafter a non-limiting embodiment of the invention comprising a combination of communication networks consisting of:
a PSTN access network dedicated to xDSL connections,
a UMTS access network dedicated to mobile radio telephone connections,
a WiFi access network dedicated to local radio connections,
an asynchronous transfer mode (ATM) transport network (RATM) adapted to transport streams coming from IP telephones (TIP) and computers (PC) (or consoles),
an IP RIP transport network adapted to transport data,
a first private network RFS1 of a first service provider,
a second private network RFS2 of a second service provider, and
a data network (RD), for example the Internet.

In the present example of a combination of communication networks, the first private network RFS1 and the second private network RFS2 are connected to the data network RD to enable their clients (main or host) to access the latter and the various RATM and RIP transport networks. Moreover, the PSTN access network (consisting of the DSLAM and the CPE (see below)) is connected to the RATM transport network, and the UMTS access network and the WiFi access network (the equipment EC) are both connected to the RIP transport network via an access equipment CM (such as an IP router, for example, separating the access aggregation network and the local network of the operator (in GSM, GPRS/EDGE and UMTS networks, this node is a GGSN)).

There is further considered hereinafter the situation of a (roaming) user having a fixed computer PC connected to a telephone line of the PSTN access network and a mobile telephone TM connected to the UMTS network and who has a subscription with the first service provider for a high bit rate connection defined by a connection profile.

Each private network RFSi (here i=1 and 2) preferably includes a “main” memory MPi storing data representing users, clients of the service provider to which it belongs, in corresponding relationship to data representing connection profiles of those client users. Each private network RFSi is called the main private network for its client users whose user data is stored in its main memory MPi.

According to the invention, each user who is a client of a service provider has a general user identifier for each type of access network enabling him to connect anywhere in the world, regardless of the access provider having an access network of the type concerned and regardless of the private network RFS to which the latter is connected by default.

This general user identifier may be directly representative of the main service provider, for example. In the case of an Internet address, it may take one of the following forms, for example: “number@serviceprovider.country” or “clientreference@serviceprovider.country” (the client reference is supplied by the service provider). That Internet address may be associated with a portion of an E-164 number (PSTN telephone number).

In the case of a mobile telephone number, it may take the form of an E-164 number in which the fixed line number and the SIM card number are associated dynamically. For example, the E-164 number of a mobile telephone is of the type +33 (0) 612xxxxxx, where 33 indicates the country (here France), after which the 6 (or the 8, where applicable) designates a mobile telephone, after which the 12 indicates one of the access operators, and the series of digits “x” designates the number of the user client.

Alternatively, it may be envisaged that each private network RFSi has a table of the correspondences between the user identifiers and the service providers of those users.

According to the invention, each access network is associated by default with a “host” private network of a service provider.

According to the invention, if a communication terminal, for example a computer PC, connects by means of a general user identifier to an access network associated, by default, with a host private network, for example the network RFS2, of a host service provider, the access network, here the network RATM, interprets that connection as a request to set up a connection, generally a high bit rate connection (here an xDSL connection).

The access network RATM then sends the host private network RFS2 the general user identifier in order for it first to determine the corresponding main service provider.

The user may where applicable be required to give his password and/or his user name (login), for example by means of a secure message sent to a portal Pi of the host private network RFSi responsible for managing host connections.

It may also be envisaged that the host service provider perform a complementary security check on the user requiring the connection in order to confirm authorization of access and/or to complete a local connection profile (i.e. a subset of the main connection profile). To this end, it may in particular request the user to enter a specific code and/or the user data already sent and/or to confirm his connection request and/or the definition of the bit rate and/or the quality of service (QoS).

A complementary check of this kind may be effected by any means, and in particular by means of a telephone call for which the number is requested of the requesting user when he is directed to the portal of the host service provider, for example. That number may also be verified against a number previously supplied by the user and contained in his connection profile. Alternatively, the check may be effected by means of an SMS or MMS message or biometric analysis.

The host private network RFS2 then determines if the main memory MP1 of the private network RFS1 of the main service provider of the user contains this general user identifier.

This may be determined by means of a request sent by the host private network RFS2 to the main private network RFS1 and requesting the sending of at least a portion of the connection profile that corresponds (where applicable) to the general user identifier. This request may contain the password and/or the user name in addition to the general user identifier. On receiving this request, the main private network RFS1 accesses its main memory MP1 to verify if the received user data corresponds to a client who has a subscription for a connection to a data network (here an xDSL network).

If so, the main private network RFS1 determines the connection profile that is stored in the main memory MP1 in corresponding relationship to the user data and then sends the host private network RFS2 at least one subset of that connection profile.

When the host private network RFS2 receives the data representing the subset of the connection profile, it copies it into an auxiliary memory MA2 which is preferably a physical component so that the data that it contains is not lost in the event of a fault or malfunction.

The storage of the subset of the connection profile in the auxiliary memory MAi is temporary. It lasts for the duration of the host connection.

The auxiliary memory MAi may also be used to store information linked to the host connections, for example their duration and/or bit rate. This information can be very useful for charging and/or billing the host connection service. In contrast to the data of the connection profile subsets, this information is stored longer, at least until the host private network has sent the charging and/or billing data to the main private network.

The person skilled in the art knows that, to set up a connection, for example a high bit rate connection, all the networks involved in that connection (access network, transport network and private network) must be configured, either under the control of a single management system or, as here, under the control of an access management system SGA, in so far as the transport networks and the access networks are concerned, and a services management system SGS1 specific to each private network RFSi.

In order to be able to configure the private network RFSi, the services management system SGSi is coupled to the main memory MPi and to the auxiliary memory MAi.

Consequently, in the example described hereinabove, once the host private network RFS2 has copied into the auxiliary memory MA2 the subset of the connection profile of the user requesting the connection, the services management system SGS2 accesses the auxiliary memory MA2 to extract therefrom the subset of the connection profile concerned.

The services management system SGS2 then configures the host private network RFS2 so that it enables the partial setting up of a connection between the requesting terminal PC and said host private network RFS2, adapted in particular to the parameters of the subset of the connection profile. At substantially the same time, the services management system SGS2 sends the access management system SGA the information necessary for configuring the transport network, here an RATM network, and the access network, here the PSTN, and in particular its xDSL digital subscriber line access multiplexer (DSLAM) access equipment, to enable the setting up of the remainder of the connection between the requesting terminal PC and said host private network RFS2, adapted in particular to the parameters of the subset of the connection profile.

An xDSL DSLAM access equipment is a concentrator installed near a customer premises equipment (CPE) switch to implement an xDSL technology. It generally consists of modems and filters for concentrating the xDSL streams and converting their protocol in order for them to be able to pass from the physical access network to their ATM transport (RATM) network or IP transport (RIP) network.

It is important to note that the configuration of the various networks may depend on local constraints of any type, for example the services policy of the host private network RFS2 and/or local legislation and/or the resources of the host private network RFS2 and the access network. Consequently, the connection that is set up using this configuration depends not only on the subset of the connection profile stored in the auxiliary memory MA2 but also on any local constraints that may apply. In other words, the connection that is set up may be substantially different from the connection profile of the user's subscription for his terminal (here his computer PC) when the latter is connected to the access network to which the telephone line to which it is usually connected belongs. For example, because of local technical constraints, the host connection may be a low bit rate connection whereas the connection profile corresponding to the main connection (via the main private network of the main service provider) is a high bit rate connection.

Once configuration has been completed, the user can immediately use the xDSL connection to access from his computer PC the data network RD to which the host private network RFS2 of the host service provider is connected.

As previously mentioned, during the host connection, the host private network RFS2 sends charging and/or billing data to the main private network RFS1 of the main service provider. The billing data may take the form of tokens. This data is intended to enable payment for the host connection by the main service provider or, which amounts to the same thing, to determine the balance of payments between the various service providers. This data can also enable the main service provider to bill his user client for a service linked to the provision of a main or host connection anywhere in the world and/or regardless of the type of terminal used.

Thanks to this charging and/or billing data, the user has a centralized billing facility managed only by his main service provider, with whom he has a subscription.

There is described hereinabove the situation of a roaming user who requires an xDSL connection to be made available, for which he has a subscription with his main service provider, although his terminal (here a computer PC) is connected to an access network associated with the host private network of another service provider.

There will now be described the situation of a user, where applicable a roaming user, who has at least two communication terminals of different types, for example a computer PC and a mobile telephone TM, and who has an xDSL subscription for his computer PC with a main access provider whose private network is the network RFS1, for example. It is further considered here that the user wishes to use at least a portion of the XDSL connection profile corresponding to his subscription to connect to the data network RD using his mobile telephone TM, if possible at a high bit rate.

In this case, the user, who is in a cell of a mobile access network (for example a UMTS network), connects his mobile telephone TM to said access network UMTS by means of his main user identifier (adapted to the UMTS access network). The UMTS access network interprets this connection as a request to set up a high bit rate connection.

Two situations can then arise.

In a first situation, the UMTS access network is associated by default with the main service provider of the user of the mobile telephone TM. The UMTS access network then sends the host private network RFS1 the general user identifier in order for it first to determine the corresponding main service provider. In this situation the host private network and the main private network are the same.

The user may be obliged to enter his password and/or his user name (login), for example by means of a secure message sent to a portal Pi of the host private network RFSi responsible for managing host connections.

It may also be envisaged that the host service provider effect a further security check on the user requesting the connection, as indicated hereinabove.

The main private network RFS1 then determines if its main memory MP1 contains this general user identifier, and where applicable proceeds to verify the user name and/or the password sent, as indicated hereinabove. Then, if these verifications yield a positive result, the main private network RFS1 copies into an auxiliary memory MA1 at least one subset of the connection profile that corresponds to the general user identifier.

The service management system SGS1 of the main private network RFS1 then accesses the auxiliary memory MA1 to extract therefrom the subset of the connection profile concerned. The service management system SGS1 then configures the main private network RFS1 so that it enables the partial setting up of a connection, where applicable a high bit rate connection, between the requesting mobile telephone TM and the main private network RFS1 adapted to the parameters of the subset of the connection profile and to any local constraints that apply. At substantially the same time, the services management system SGS1 sends the access management system SGA the information necessary for configuring the transport network, here RIP, and the access network, here UMTS, to enable the setting up of the remainder of the connection, where applicable at a high bit rate, between the requesting mobile telephone TM and the main private network RFS1, adapted to the parameters of the subset of the connection profile and to any local constraints that may apply.

Once configuration has been completed, the user can immediately use the connection, where applicable at a high bit rate, to access from his mobile telephone TM the data network RD to which the main private network RFS1 of the main service provider is connected. As indicated hereinabove, throughout the connection, charging and/or billing information is exchanged between the host private network and the main private network for billing the user and for determining the balance of payments between the mobile access provider and the fixed service provider.

In a second situation, the UMTS access network is associated by default with a service provider that is not the main service provider of the user of the mobile telephone TM. The UMTS access network sends the general user identifier to the host private network RFS2, with which it is associated by default, in order for it first to determine the corresponding main service provider. In this situation the host private network RFS2 and the main private network RFS1 are different.

The host private network RFS2 then determines if the main memory MP1 of the private network RFS1 of the main service provider of the user contains this general user identifier.

The user may be required to enter his password and/or his user name (login), for example by means of a secure message sent to a portal Pi of the host private network RFSi responsible for managing the host connections.

It may also be envisaged that the host service provider perform a further security check on the user requesting the connection, as indicated hereinabove.

This determination may be effected as indicated hereinabove by means of a request sent by the host private network RFS2 to the main private network RFS1 requesting the sending of at least part of the connection profile that corresponds (where applicable) to the general user identifier. This request may contain the password and/or the user name in addition to the general user identifier. On receiving this request, the main private network RFS1 accesses its main memory MP1 to verify if the user data received in fact corresponds to a client who has a subscription for a high bit rate connection (here XDSL).

If so, the main private network RFS1 determines the connection profile that is stored in the main memory MP1 in corresponding relationship to the user data and then sends the host private network RFS2 at least one subset of that connection profile.

When the host private network RFS2 receives the data representing the subset of the connection profile, it copies it into an auxiliary memory MA2.

The services management system SGS2 of the host private network RFS2 then accesses the auxiliary memory MA2 to extract therefrom the subset of the connection profile concerned. The services management system SGS2 then configures the host private network RFS2 so that it enables the partial setting up of a connection, where applicable at a high bit rate, between the requesting mobile telephone TM and said host private network RFS2, adapted to the parameters of the subset of the connection profile and to any local constraints that may apply. At substantially the same time, the services management system SGS2 sends the access management system SGA the information necessary for configuring the transport network, here the RIP network, and the access network, here the UMTS network, to enable the setting up of the remainder of the connection, where applicable at a high bit rate, between the requesting mobile telephone TM and said host private network RFS2, adapted to the parameters of the subset of the connection profile and to any local constraints that may apply.

Once configuration has been completed, the user can immediately use the connection, where applicable at a high bit rate, to access from his mobile telephone TM the data network RD to which the host private network RFS2 of the host service provider is connected.

As indicated hereinabove, during the host connection, the host private network RFS2 sends billing data to the main private network RFS1 of the main service provider.

Many other examples of the use of the method of the invention corresponding to other situations may be envisaged.

Thus it may be envisaged that a user have a subscription for a high bit rate connection adapted to his mobile telephone TM (or to a WiFi or WiMAX terminal), and wishes to use at least a portion of the connection profile of that subscription for another of his terminals, possibly of another type, for example a PC, an IP telephone or a games console.

The invention is not limited to the embodiments of a method of setting up connections described hereinabove by way of example only, and encompasses all variants that the person skilled in the art might envisage that fall within the scope of the following claims.

1. A method of setting up connections for access to at least one data network from communication terminals used by users having subscriptions respectively corresponding to connection profiles with “main” service providers, via private networks of service providers and fixed or mobile access networks of different types, interconnected by transport networks of different types, which method comprises: i) assigning each of said users a general user identifier for each type of access network and storing each general user identifier in corresponding relationship to the connection profile in a “main” memory; ii) in the event of connection of a terminal to one of said access networks, associated with a host private network of a host service provider, by means of a general user identifier, determining in said main memory if it contains said general user identifier and, if so, copying at least a subset of the corresponding connection profile into an auxiliary memory of said host private network; iii) configuring said host private network, said access network to which said terminal is connected and the transport network that connects them as a function of at least a part of said copied subset so as to set up a connection between said terminal and said host private network, said host private network sending charging and/or billing data to said private network of said main service provider in order for it to manage the billing of each host connection for its user clients and/or for it to bill the service rendered for each host connection.

2. The method according to claim 1, wherein there is communicated to the host private network of the host service provider, by means of the terminal connected to the associated access network, data representing said general user identifier and a user name and/or a password, so as to authenticate said user.

3. The method according to claim 2, wherein said user data is communicated by means of at least one secure message.

4. The method according to claim 2, wherein, on receiving said user data, said host private network of said host service provider determines the main service provider of said user in order to send its main private network said user data, and, on receiving said user data, said main private network verifies that it in fact corresponds to a client having a subscription for a connection, and, if so, it determines in said main memory the subscription connection profile in order to send to said host private network of said host service provider a subset of said connection profile in order for it to be stored in said auxiliary memory.

5. The method according to claim 1, wherein said host service provider performs an additional security check on a user requesting a connection in order to confirm access authorization and/or to complete a local connection profile.

6. The method according to claim 5, wherein said additional security check comprises setting up a telephone connection with said user in order to request from him a connection request confirmation and/or the communication of identification data.

7. The method according to claim 1, wherein said host private network initiates the setting up of the connection with said terminal as a function of said subset of the connection profile stored in said auxiliary memory and local constraints.

8. The method according to claim 1, comprising providing at least one access management system connected to said transport networks and to said access networks associated therewith so as to configure them selectively to set up said connections.

9. The method according to claim 8, including connecting said access management system to said private networks in order to configure them selectively for setting up said connections.

10. The method according to claim 1, including providing services management systems respectively connected to said private networks in order to configure them selectively for setting up said connections.

11. The method according to claim 1, including providing a main memory and an auxiliary memory in each of said private networks of said service providers.
